(19) United States
(12) Patent Application Publication
(10) Pub. No.: US 2022/0206290 A1
(43) Pub. Date: Jun. 30, 2022

(54) ADAPTIVE BEAM DIVERGENCE CONTROL IN LIDAR

(71) Applicant: BEIJING VOYAGER TECHNOLOGY CO., LTD., Beijing (CN)

(72) Inventors: Yue Lu, Mountain View, CA (US); Youmin Wang, Berkeley, CA (US)

(73) Assignee: BEIJING VOYAGER TECHNOLOGY CO., LTD., Beijing (CN)

(21) Appl. No.: 17/137,279

(22) Filed: Dec. 29, 2020

(51) Int. Cl. G02B 26/12; G02B 27/00; G02B 26/10

(52) U.S. Cl. CPC G02B 26/126; G02B 26/106; G02B 27/0031

(57) ABSTRACT

Embodiments of the disclosure provide a transmitter, an optical sensing system, and an optical sensing method. An exemplary optical sensing system includes an optical source configured to emit optical signals. The optical sensing system further includes a scanner configured to steer the optical signals towards an environment surrounding the optical sensing system at a plurality of scanning angles. A surface curvature of the scanner is adaptively adjusted to change a divergence of the optical signals at the respective scanning angles. The optical sensing system additionally includes a receiver configured to receive the optical signals returning from the environment.

### TECHNICAL FIELD

The present disclosure relates to beam divergence control in a light detection and ranging (LiDAR) system, and more particularly, to adaptive beam divergence control by adjusting surface curvature of a scanning mirror in the LiDAR system.

### BACKGROUND

Higher resolution is a key factor in LiDAR application as the point cloud density is crucial to the successful object recognition in perception algorithms. To achieve higher resolution, one technique that can be used is to scan the far-field objects with a scanning flash fashion, while detecting the back scattered signal using a detector array. The elements in the detector array are individually addressable. Each element covers an even smaller filed-of-view (FOV) compared to the divergence of the TX outgoing laser beam, and therefore the resolution of the entire system can be enhanced. For example, FIG. 1 illustrates a transmitter outgoing beam size of laser beam 10 compared to a 1-D detector array 20 in the receiver. Detector array 20 includes multiple detector elements 20-A to 20-F that collectively cover an FOV similar to the size of laser beam 10.

To guarantee each element could receive enough light signal from the far-field objects within the detector array, it is important to control the TX outgoing laser beam spot to be uniform and unchanged over the entire scanned FOV. However, in many cases, due to the scanning mirror aperture change or mirror flatness change, for example in a MEMS scanning mirror, both the laser beam flatness and light intensity distribution changes over time. Accordingly, there is a need to adaptively control the divergence of the transmitter outgoing beam.

Embodiments of the disclosure address the above problems by adaptively adjusting a surface curvature of the scanning mirror used in the LiDAR system.

### SUMMARY

Embodiments of the disclosure provide an exemplary optical sensing system. The optical sensing system includes an optical source configured to emit optical signals. The optical sensing system further includes a scanner configured to steer the optical signals towards an environment surrounding the optical sensing system at a plurality of scanning angles. A surface curvature of the scanner is adaptively adjusted to change a divergence of the optical signals at the respective scanning angles. The optical sensing system additionally includes a receiver configured to receive the optical signals returning from the environment.

Embodiments of the disclosure also provide an exemplary optical sensing method for an optical sensing system comprising a scanner. The method includes emitting optical signals towards the scanner and adaptively adjusting a surface curvature of the scanner to change a divergence of the optical signals corresponding to a plurality of scanning angles. The method further includes steering the optical signals towards an environment surrounding the optical sensing system at the plurality of scanning angles. The method additionally includes receiving the optical signals returning from the environment.

Embodiments of the disclosure further provide an exemplary transmitter for an optical sensing system. The exemplary transmitter includes an optical source configured to emit optical signals. The exemplary transmitter further includes a scanner configured to steer the optical signals towards an environment surrounding the optical sensing system at a plurality of scanning angles. A surface curvature of the scanner is adaptively adjusted to change a divergence of the optical signals at the respective scanning angles.

It is to be understood that both the foregoing general description and the following detailed description are exemplary and explanatory only and are not restrictive of the present disclosure, as claimed.

### BRIEF DESCRIPTION OF THE DRAWINGS

FIG. 1 illustrates a transmitter outgoing beam size compared to a detector array in a flash scanning LiDAR.

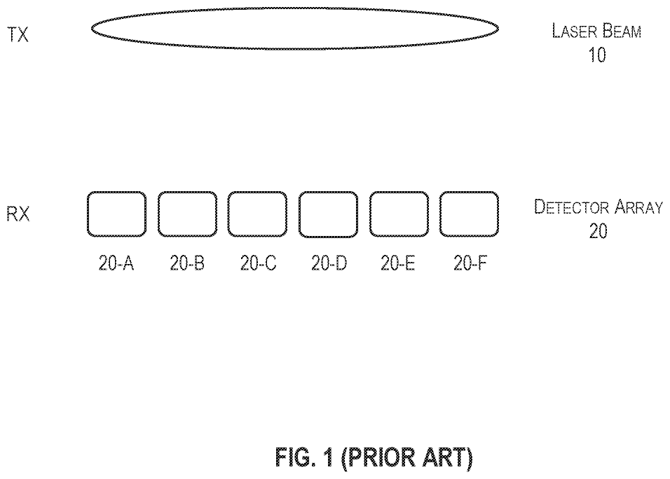

FIG. 2 illustrates a schematic diagram of an exemplary vehicle equipped with a LiDAR system containing a surface curvature adjustable scanner, according to embodiments of the disclosure.

FIG. 3 illustrates a block diagram of an exemplary LiDAR system containing a surface curvature adjustable scanner, according to embodiments of the disclosure.

FIG. 4 illustrates a top view of an exemplary scanner with an adjustable surface curvature and a diagram showing variation of its scanning angle, according to embodiments of the disclosure.

FIG. 5 illustrates a cross-sectional view of an exemplary scanning mirror with flat, convex, and concave surface curvatures, according to embodiments of the disclosure.

FIG. 6 illustrates a schematic diagram of an exemplary control system for adjusting the surface curvature of a scanning mirror, according to embodiments of the disclosure.

FIG. 7 is a flow chart of an exemplary optical sensing method of a LiDAR system containing a surface curvature adjustable scanner, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Embodiments of the present disclosure provide optical sensing system containing a surface curvature adjustable scanner. According to one example, the optical sensing system may be a flash scanning LiDAR. The optical sensing system may include an optical source, such as a laser emitter, configured to emit optical signals. The optical signals may be collimated by a collimation lens into an initial divergence. For example, the beam spot size at the initial divergence may be comparable to the size of the detector array used in the receiver of the optical sensing system. The optical sensing system may further include a scanner configured to steer the optical signals towards an environment surrounding the optical sensing system at a plurality of scanning angles. For example, the optical sensing system is programed to scan a predetermined FOV and the scanner rotates to sequentially refract the emitted optical signals towards multiple directions over the entire FOV. Each of those steering directions of the scanner is also known as a scanning angle of the scanner. In some embodiments, the scanner may be implemented using a scanner mirror, e.g., a micro-electromechanical system (MEMS) mirror or mirror array. The MEMS mirror is actuated to rotate to the respective scanning angles through MEMS actuation.

As the scanning mirror rotates, the emitted optical signals are incident on the surface of the scanning mirror at different angles. The varying angular velocity during the resonant scanning may also cause local deformation in the mirror surface. As a result, the outgoing beam divergence of the optical signals after being refracted by the scanning mirror is distorted and varies among different scanning angle and is thus nonuniform over the FOV. In order to compensate for the nonuniform divergence, the disclosed scanner is specially designed to have an adjustable surface curvature, which is adaptively adjusted to correct the deformation on the mirror surface, thus changing the divergence of the optical signals to be substantially uniform across the respective scanning angles. For example, when the divergence needs to be increased, the surface curvature can be adjusted to be convex and when the divergence needs to be decreased, the surface curvature can be adjusted to be concave. In some embodiments, during each scan, the surface curvature may be actuated to change gradually and continuous as the scanner rotates among the scanning angles. In some embodiments, the curvature adjustment value may be linearly proportional to each scanning angle.

The control of the surface curvature may be realized using various different actuation methods, e.g., piezoelectric actuation, electro-thermal actuation, and parallel plate actuation, etc. For example, a piezoelectric material may be coated on the scanning mirror or included in the scanning mirror to form a piezoelectric actuator. A voltage applied as a curvature control signal to the piezoelectric actuator will cause a mechanical displacement in the scanner that bends the surface curvature. As another example, an electro-thermal actuator may be formed and an electrical signal applied to the electro-thermal actuator may cause a thermal expansion in the scanner that bends the surface curvature. In some embodiments, the curvature actuators may be fabricated in the same MEMS structure as the MEMS minor.

By dynamically changing the surface curvature of the scanner in real time, the beam divergence of the outgoing transmitter beam may be adaptively controlled at a uniform and constant level. As a result, the receiver of the optical sensing system will receive optical signals returning from the environment at a substantially same beam spot size. In some embodiments, receiver may use a detector array to receive the optical signals. In some embodiments, the received beam spot size may be substantially the same or comparable to the size of the detector array used in the receiver.

The features and advantages described herein are not all-inclusive and many additional features and advantages will be apparent to one of ordinary skill in the art in view of the figures and the following descriptions.

The disclosed LiDAR system containing a surface curvature adjustable scanner can be used in many applications. For example, the disclosed LiDAR system can be used in advanced navigation technologies, such as to aid autonomous driving or to generate high-definition maps, in which the optical sensing system can be equipped on a vehicle.

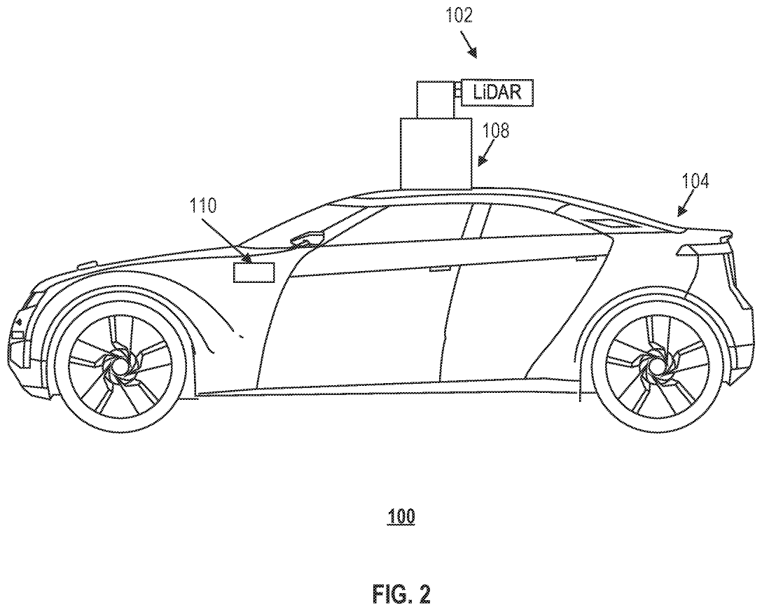

FIG. 2 illustrates a schematic diagram of an exemplary vehicle equipped with an optical sensing system containing a surface curvature adjustable scanner, according to embodiments of the disclosure. Consistent with some embodiments, vehicle 100 may be a survey vehicle configured for acquiring data for constructing a high-definition map or 3-D buildings and city modeling. Vehicle 100 may also be an autonomous driving vehicle.

As illustrated in FIG. 2, vehicle 100 may be equipped with an optical sensing system, e.g., a LiDAR system 102 (also referred to as “LiDAR system 102” hereinafter) mounted to a body 104 via a mounting structure 108. Mounting structure 108 may be an electromechanical device installed or otherwise attached to body 104 of vehicle 100. In some embodiments of the present disclosure, mounting structure 108 may use screws, adhesives, or another mounting mechanism. Vehicle 100 may be additionally equipped with a sensor 110 inside or outside body 104 using any suitable mounting mechanisms. Sensor 110 may include sensors used in a navigation unit, such as a Global Positioning System (GPS) receiver and one or more Inertial Measurement Unit (IMU) sensors. It is contemplated that the manners in which LiDAR system 102 or sensor 110 can be equipped on vehicle 100 are not limited by the example shown in FIG. 2 and may be modified depending on the types of LiDAR system 102 and sensor 110 and/or vehicle 100 to achieve desirable 3D sensing performance.

Consistent with some embodiments, LiDAR system 102 and sensor 110 may be configured to capture data as vehicle 100 moves along a trajectory. For example, a transmitter of LiDAR system 102 may be configured to scan the surrounding environment. LiDAR system 102 measures distance to a target by illuminating the target with laser beams and measuring the refracted/scattered pulses with a receiver. The laser beams used for LiDAR system 102 may be ultraviolet, visible, or near-infrared, and may be pulsed or continuous wave laser beams. In some embodiments of the present disclosure, LiDAR system 102 may capture point clouds including depth information of the objects in the surrounding environment, which may be used for constructing a high-definition map or 3-D buildings and city modeling. As vehicle 100 moves along the trajectory, LiDAR system 102 may continuously capture data including the depth information of the surrounding objects (such as moving vehicles, buildings, road signs, pedestrians, etc.) for map, building, or city modeling construction.

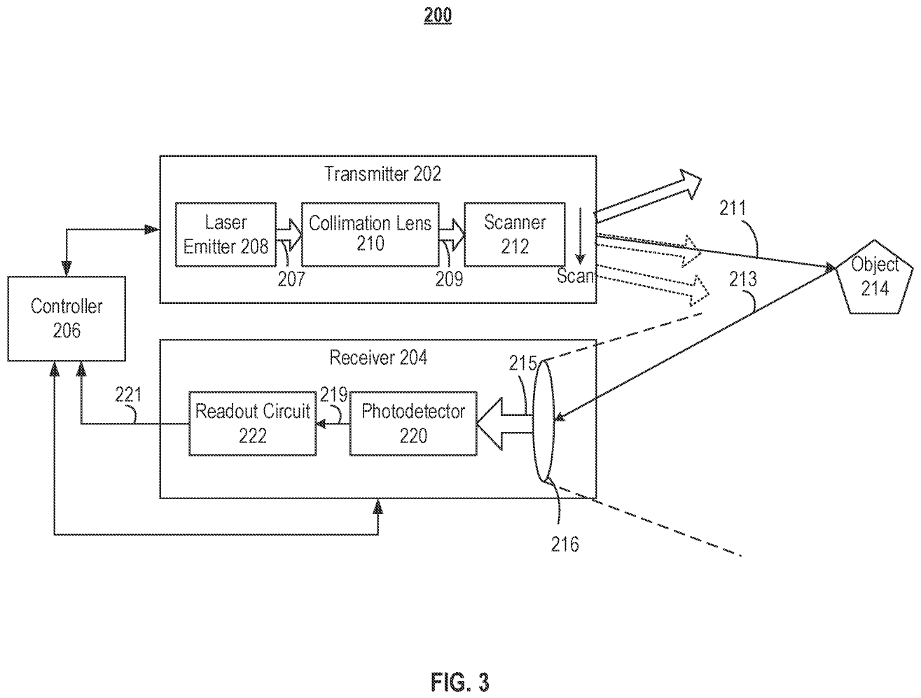

FIG. 3 illustrates a block diagram of an exemplary LiDAR system containing a surface curvature adjustable scanner, according to embodiments of the disclosure. In some embodiments, LiDAR system 102 may be a scanning flash LiDAR, a semi-coaxial LiDAR, a coaxial LiDAR, etc. As illustrated, LiDAR system 102 may include a transmitter 202, a receiver 204, and a controller 206 coupled to transmitter 202 and receiver 204. Transmitter 202 may further include a laser emitter 208 for emitting optical signals, a collimation lens 210 for collimating the optical signals to an initial divergence, and a scanner 212 for steering the emitted optical signals at various scanning angles to scan a predetermined FOV. Consistent with the present disclosure, scanner 212 may have an adjustable surface curvature that can be controlled, e.g., by controller 206, in order to compensate for the variation in the beam divergence at different scanning angles. Receiver 204 may further include a receiving lens 216, a detector 220, and a readout circuit 222. In some embodiments, receiver 204 may further include an electric shutter 218 that is configured to limit the returning optical signals to be detected by detector 220 within certain time windows.

Transmitter 202 may emit optical beams (e.g., pulsed laser beams, continuous wave (CW) beams, frequency modulated continuous wave (FMCW) beams) along multiple directions. Transmitter 202 may include a laser emitter 208, a collimation lens 210, and a scanner 212 with an adjustable surface curvature. According to one example, transmitter 202 may sequentially emit a series of laser beams in different directions (or at different scanning angles) within a scan FOV (e.g., a range in angular degrees), as illustrated in FIG. 3. The emitted laser beams may have varying beam divergences.

Laser emitter 208 may be configured to emit laser beams 207 (also referred to as “native laser beams”) to collimation lens 210. For instance, laser emitter 208 may generate laser beams in the ultraviolet, visible, or near-infrared wavelength range, and provide the generated laser beams to collimation lens 210. In some embodiments of the present disclosure, depending on underlying laser technology used for generating laser beams, laser emitter 208 may include one or more of a double heterostructure (DH) laser emitter, a quantum well laser emitter, a quantum cascade laser emitter, an interband cascade (ICL) laser emitter, a separate confinement heterostructure (SCH) laser emitter, a distributed Bragg refractor (DBR) laser emitter, a distributed feedback (DFB) laser emitter, a vertical-cavity surface-emitting laser (VCSEL) emitter, a vertical-external-cavity surface-emitting laser (VECSEL) emitter, an extern-cavity diode laser emitter, etc., or any combination thereof. Depending on the number of laser emitting units in a package, laser emitter 208 may include a single emitter containing a single light-emitting unit, a multi-emitter unit containing multiple single emitters packaged in a single chip, an emitter array or laser diode bar containing multiple (e.g., 10, 20, 30, 40, 50, etc.) single emitters in a single substrate, an emitter stack containing multiple laser diode bars or emitter arrays vertically and/or horizontally built up in a single package, etc., or any combination thereof. Depending on the operating time, laser emitter 208 may include one or more of a pulsed laser diode (PLD), a CW laser diode, a Quasi-CW laser diode, etc., or any combination thereof. Depending on the semiconductor materials of diodes in laser emitter 208, the wavelength of incident laser beams 207 may be greater than 700 nm, such as 760 nm, 785 nm, 808 nm, 848 nm, 870 nm, 905 nm, 940 nm, 980 nm, 1064 nm, 1083 nm, 1310 nm, 1370 nm, 1480 nm, 1512 nm, 1550 nm, 1625 nm, 1654 nm, 1877 nm, 1940 nm, 2000 nm, etc. It is understood that any suitable laser source may be used as laser emitter 208 for emitting laser beams 207 at a proper wavelength.

Collimation lens 210 may include optical components (e.g., lenses, mirrors) that can shape the laser beam and collimate the laser beam into a narrower laser beam to increase the scan resolution and the range to scan object 214. In some embodiments, collimation lens 210 may include lenses with various shapes and structures that are configured to collimate laser beams 207 into laser beams 209 with an initial beam divergence.

In some embodiments, transmitter 202 may also include a scanner 212 configured to steer laser beams 209 to an object 214 in a range of scanning angles (collectively forming the FOV of transmitter 202). In some embodiments, object 214 may be made of a wide range of materials including, for example, non-metallic objects, rocks, rain, chemical compounds, aerosols, clouds, and even single molecules. In some embodiments, at each time point during the scan, a scanner may steer laser beams 211 to object 214 in a direction within a range of scanning angles by rotating a deflector, such as a micromachined mirror assembly.

Consistent with the present disclosure, scanner 212 may use a scanning mirror that has an adjustable surface curvature to compensate for the variation in the beam divergence at different scanning angles. In some embodiments, the surface curvature can be dynamically and adaptively controlled, e.g., by controller 206, at the respective scanning angles. For example, the surface curvature can be adjusted to convex, concave, or flat to increase, decrease, or maintain the divergence of the laser beam at each scanning angle to ensure that the divergence of laser beams 211 is substantially uniformed and unchanged over the entire FOV. In some embodiments, the amount of surface curvature adjustment may be linearly proportional to each scanning angle. The surface curvature may be adjusted through various actuation methods. For example, piezoelectric actuation can be used to cause a mechanical displacement in scanner 212 that bends its surface curvature upon the application of a voltage control signal. As another example, electro-thermal actuation can also be used to cause a thermal expansion in scanner 212 that bends its surface curvature upon the application of an electrical control signal. Other examples of actuation methods may include parallel plate actuation, etc.

Receiver 204 may be configured to detect returned laser beams 213 returned from object 214. Upon contact, laser light can be refracted/scattered by object 214 via backscattering, such as Rayleigh scattering, Mie scattering, Raman scattering, and fluorescence. Returned laser beams 213 may be in a same or different direction from laser beams 211. In some embodiments, receiver 204 may collect laser beams returned from object 214 and output signals refracting the intensity of the returned laser beams.

As illustrated in FIG. 3, receiver 204 may include a receiving lens 216, a detector 220, and a readout circuit 222. Receiving lens 216 may be configured to focus and converge the returning optical signal directly on detector 220 as a focused laser beam 215. Detector 220 may be configured to detect the focused laser beam 215. For a scanning flash LiDAR, detector 220 may include a detector array including multiple detector elements (e.g., photodetectors) arranged in 1-D or 2-D. In some embodiments, each detector element may be a PIN detector, an avalanche photodiode (APD) detector, a single photon avalanche diode (SPAD) detector, a silicon photo multiplier (SiPM) detector, or the like. In some embodiments, the received beam spot size may be substantially the same or comparable to the size of the detector array. Each detector element may detect a portion of the returned laser beam, therefore achieving a higher resolution than the beam spot size. In some embodiments, detector 220 may convert the laser beam into an electrical signal 219 (e.g., a current or a voltage signal). Electrical signal 219 may be an analog signal which is generated when photons are absorbed in a photodiode included in each detector element of detector 220.

Readout circuit 222 may be configured to integrate, amplify, filter, and/or multiplex signal detected by detector 220 and transfer the integrated, amplified, filtered, and/or multiplexed signal 221 onto an output port (e.g., controller 206) for readout. Each detector element in detector 220 may be individually addressed and connect to its own readout circuit. In some embodiments, readout circuit 222 may act as an interface between detector 220 and a signal processing unit (e.g., controller 206). Depending on the configurations, readout circuit 222 may include one or more of a transimpedance amplifier (TIA), an analog-to-digital converter (ADC), a time-to-digital converter (TDC), or the like.

Controller 206 may be configured to control transmitter 202 and/or receiver 204 to perform detection/sensing operations. For instance, controller 206 may control laser emitter 208 to emit laser beams 207, or control scanner 212 to steer laser beams 211 in different directions. In some embodiments, controller 206 may also implement data acquisition and analysis. For instance, controller 206 may collect digitalized signal information from readout circuit 222, determine the distance of object 214 from LiDAR system 102 according to the travel time of laser beams, and construct a high-definition map or 3-D buildings and city modeling surrounding LiDAR system 102 based on the distance information of object(s) 214. In some embodiments, controller 206 may be coupled to scanner 212 to adjust the surface curvature in order to control the divergence of outgoing laser beams 211, as further described in detail below.

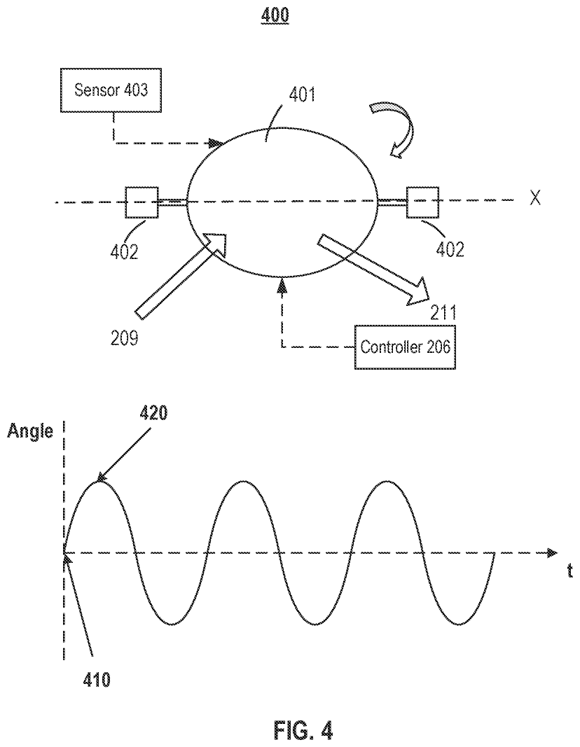

FIG. 4 illustrates a top view of an exemplary scanner 400 with an adjustable surface curvature and a diagram showing variation of its scanning angle, according to embodiments of the disclosure. As illustrated in FIG. 4, scanner 400 may include a scanning mirror 401 and anchors 402 on which scanning mirror 401 is mounted on. In some embodiments, scanning mirror 401 may be a MEMS mirror actuated by MEMS actuators (not explicitly shown) to rotate scanning mirror 401 around axis X. During each scan, scanning mirror 401 may cycle through a range of scanning angles in order to refract laser beams 209 and steer refracted laser beams 211 in different directions in the FOV. A sensor 403 may be coupled to scanning mirror 401 to detect its actual scanning angle in real-time.

In some embodiments, axis X may be the fast scanning axis and uses resonant scanning. For example, a sinusoidal actuation signal may be applied to actuate the rotation of scanning mirror 401. FIG. 4 further shows an exemplary diagram of the varying scanning angle of scanning mirror 401. Sinusoidal scanning causes local deformations on the surface of scanning mirror 401 due to the varying angular velocities at different scanning angles. For example, scanning mirror 401 has a different angular velocity at first scanning angle 410 (close to 0°) compared to second scanning angle 420 (close to maximum angle, e.g., 0°). In addition, the incident angle of laser beams 209 varies when scanning mirror 401 is rotated to different scanning angles. Both the variation in local mirror surface deformation and variation in the beam incident angle cause a variation in the divergence of outgoing laser beams 211 across the different scanning angles. For example, the divergence may be 0.05 mm×0.05 mm at first scanning angle 410, but 0.2 mm×0.2 mm at second scanning angle 420 as there is a large divergence distortion caused by the surface deformation at second scanning angle 420.

In order to compensate for the variation in the beam divergence caused by the surface deformation at different scanning angles, scanning mirror 401 may be designed to have an adjustable surface curvature. The surface curvature may be dynamically and adaptively controlled, e.g., by controller 206. By adjusting the surface curvature of scanning mirror 401, the divergence of outgoing laser beams 211 may be adjusted to a substantially same level, i.e., uniform, over the entire FOV. In some embodiments, at each scanning angle, the surface curvature may be adjusted to a convex, concave, or flat shape to increase, decrease, or maintain the divergence of laser beam 211, respectively. For example, scanning mirror 401 may be adjusted to a convex or concave surface, in order the level the divergence among the different scanning angles. By adjusting the surface curvature, the surface deformation caused by rotation is corrected and the mirror is surface flattened.

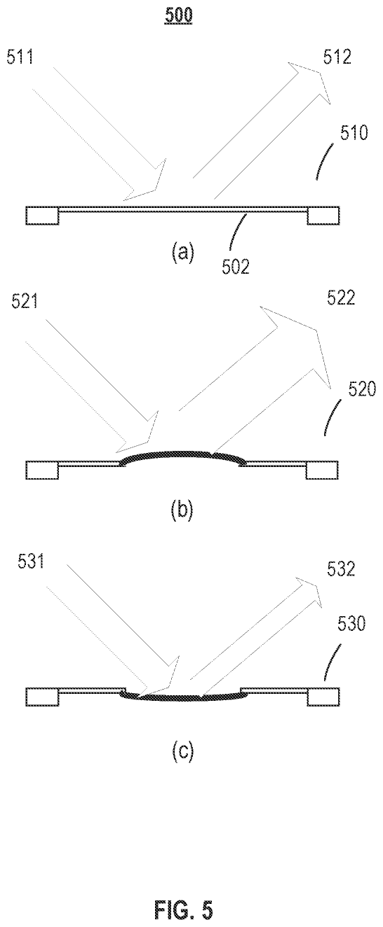

FIG. 5 illustrates a cross-sectional view of an exemplary scanning mirror 500 with flat, convex, and concave surface curvatures, according to embodiments of the disclosure. In (a), scanning mirror 500 has a flat surface curvature 510. As a result, the divergence of outgoing laser beam 512 is the same as that of incident laser beam 511. In (b), scanning mirror 500 is adjusted to have a convex surface curvature 520. As a result, divergence of outgoing laser beam 522 increases over that of incident laser beam 521. That is, convex surface curvature 520 provides additional divergence to the outgoing laser beam. In (c), scanning mirror 500 is adjusted to have a concave surface curvature 530. As a result, divergence of outgoing laser beam 532 decreases over that of incident laser beam 531. That is, concave surface curvature 530 provides a reduced amount of divergence to the outgoing laser beam.

In some embodiments, the surface curvature may be adjusted through various actuation methods, e.g., piezoelectric actuation, electro-thermal actuation, and parallel plate actuation, etc. For example, a piezoelectric actuator may be formed on scanning mirror 500 to cause a mechanical displacement that bends its surface curvature upon the application of a voltage control signal. As another example, an electro-thermal actuator may be formed to cause a thermal expansion in scanning mirror 500 that bends its surface curvature upon the application of an electrical control signal. Other examples of actuation methods are also contemplated as long as they can be integrated with the MEMS structure.

In some embodiments, the surface curvature actuator of scanning mirror 401 may be formed on its bottom surface opposite to the top surface shown in FIG. 4 that receives laser beams 209, in order to not interfere with the optical path. For example, as shown in FIG. 5, the actuator may be formed on surface 502 of scanning mirror 500. In some embodiments, the actuator may be formed by coating a layer of material (e.g., piezoelectrical material or thermoelectric material) on surface 502. Examples of piezoelectrical material may include crystals, certain ceramics, enamel, etc. Examples of thermoelectric material may include glass, semiconductors, alloys, complex crystals, etc.

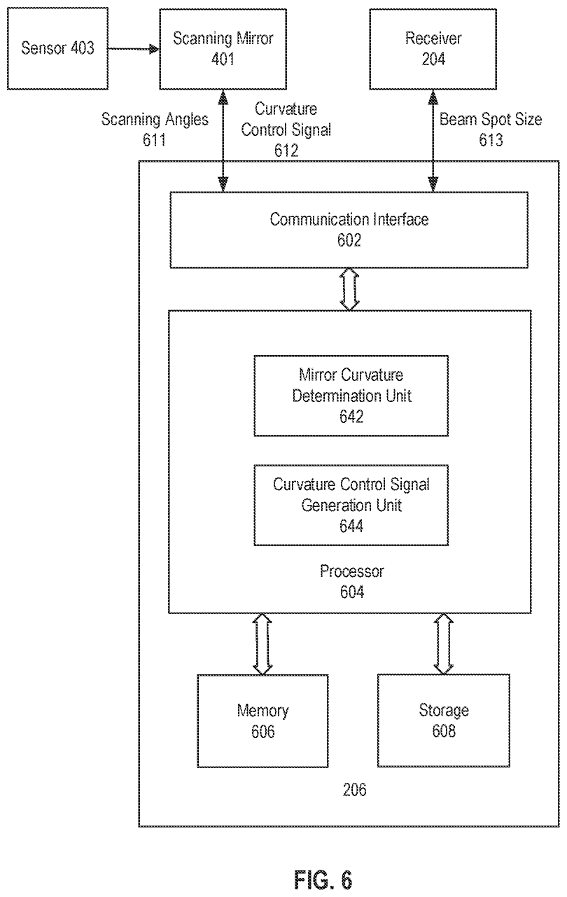

In some embodiments, controller 206 may be coupled to the actuator to provide a control signals to control the actuation of the surface curvature. FIG. 6 illustrates a schematic diagram of an exemplary controller 206 for adjusting the surface curvature of a scanning mirror, according to embodiments of the disclosure. As shown by FIG. 6, controller 206 may include a communication interface 602, a processor 604, a memory 606, and a storage 608. In some embodiments, controller 206 may have different modules in a single device, such as an integrated circuit (IC) chip (e.g., implemented as an application-specific integrated circuit (ASIC) or a field-programmable gate array (FPGA)), or separate devices with dedicated functions. In some embodiments, one or more components of controller 206 may be located in a cloud or may be alternatively in a single location (such as inside a mobile device) or distributed locations. Components of controller 206 may be in an integrated device or distributed at different locations but communicate with each other through a network (not shown). Consistent with the present disclosure, controller 206 may be configured to dynamically control the surface curvature of scanning mirror 401. In some embodiments, controller 206 may also perform various other control functions of other components of LiDAR system 102.

Communication interface 602 may send signals to and receive signals from components of transmitter 202 and receiver 204 via wired communication methods, such as Serializer/Deserializer (SerDes), Low-voltage differential signaling (LVDS), Serial Peripheral Interface (SPI), etc. In some embodiments, communication interface 602 may optionally use wireless communication methods, such as a Wireless Local Area Network (WLAN), a Wide Area Network (WAN), wireless networks such as radio waves, a cellular network, and/or a local or short-range wireless network (e.g., Bluetooth™), etc. Communication interface 602 can send and receive electrical, electromagnetic or optical signals in analog form or in digital form.

Consistent with some embodiments, communication interface 602 may receive scanning angles 611 at various time points, from transmitter 202. For example, communication interface 602 may receive the actual scanning angles 611 measured in real-time by sensor 403. Communication interface 602 may provide command signals, e.g., curvature control signal 612, to scanning mirror 401 to drive the curvature adjustment actuators to dynamically adjust the surface curvature of scanning mirror 401. In some embodiments, communication interface may further receive beam spot size 613 from receiver 204 to verify whether the beam divergence is substantially uniform and perform feedback control the surface curvature based thereon. Communication interface 602 may also receive acquired signals from and provide control signals to various other components of LiDAR system 102.

Processor 604 may include any appropriate type of general-purpose or special-purpose microprocessor, digital signal processor, or microcontroller. Processor 604 may be configured as a separate processor module dedicated to controlling the adjustable surface curvature of scanning mirror 401, at different scanning angles. Alternatively, processor 604 may be configured as a shared processor module for performing other functions of LiDAR controls.

Memory 606 and storage 608 may include any appropriate type of mass storage provided to store any type of information that processor 604 may need to operate. Memory 606 and storage 608 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory 606 and/or storage 608 may be configured to store one or more computer programs that may be executed by processor 604 to perform functions disclosed herein. For example, memory 606 and/or storage 608 may be configured to store program(s) that may be executed by processor 604 for controlling the adjustable receiving aperture in a LiDAR. In some embodiments, memory 606 and/or storage 608 may further store a predetermined look-up table (LUT) that maps various scanning angle to corresponding pre-determined curvature adjustment values. In some embodiments, memory 606 and/or storage 608 may also store intermediate data generated during the optical sensing process.

As shown in FIG. 6, processor 604 may include multiple modules, such as a mirror curvature determination unit 642 and a curvature control signal generation unit 644, and the like. These modules can be hardware units (e.g., portions of an integrated circuit) of processor 604 designed for use with other components or software units implemented by processor 604 through executing at least part of a program. The program may be stored on a computer-readable medium, and when executed by processor 604, it may perform one or more functions. Although FIG. 6 shows units 642 and 644 both within one processor 604, it is contemplated that these units may be distributed among different processors located closely or remotely with each other.

In some embodiments, mirror curvature determination unit 642 may calculate the amount of curvature adjustment according to the current scanning angle of the scanning mirror. In some embodiments, the current scanning angle may be determined based on the scanning parameters, e.g., the sinusoidal actuation signal, assuming that the actuation can accurately rotate the scanning mirror to the planned scanning angle. In some alternative embodiments, the current scanning angle can be measured, e.g., by sensor 403, in real-time.

In some embodiments, the surface curvature adjustment value may be determined to compensate for the mirror surface deformation, which is linearly proportional to the scanning angle of the scanning mirror. For example, the deformation amount can be generally described by Equation (1):

δ∝θf²D⁵t² (1)

where δ indicates the deformation amount of the scanning mirror, δ denotes the current scanning angle, f is the resonant frequency of the MEMS actuation signal for the fast axis scanning, D is the size (diameter) of the scanning mirror, and t is the thickness of the mirror.

In reality, at the same scanning angle, deformation δ may be different at different locations on the mirror, i.e., there is a δ(x, y) distribution on the mirror surface. δ(x, y) distribution may be determined, e.g., using Finite Element Analysis (FEA). Surface deformation δ(x,y) causes distortion in the beam shape and therefore the target for correction by the present disclosure. Based on δ(x, y), an effective curvature R may be determined by, e.g., a 2D parabolic fitting to δ(x, y). A resulting fitted surface profile can be a concave or context shape as shown in FIG. 5. Accordingly, the amount of curvature adjustment Δδ can be determined accordingly to counter the effective curvature R in order to flatten the mirror surface such that R->∞.

In some embodiments, the curvature adjustment values Δδ may be pre-calculated for various scanning angles and stored in a LUT. Accordingly, mirror curvature determination unit 642 can determine the curvature adjustment value for each current scanning angle by looking it up in the LUT. In some alternative embodiments, mirror curvature determination unit 642 may be programed to calculate the adjustment values on the fly using the current scanning angles. This may enable controller 206 to additionally consider other information in determining the adjustment amount, e.g., beam spot size 613 as actually received by receiver 204, and perform feedback control based thereon. For example, if beam spot size 613 is too small (e.g., not cover the entire receiving aperture), mirror curvature determination unit 642 may add additional amount of curvature to the value otherwise calculated. Similarly, if beam spot size 613 is too large (e.g., exceed the entire receiving aperture), mirror curvature determination unit 642 may offset the calculated amount of curvature adjustment by a value.

Curvature control signal generation unit 644 may generate control signals according to the determined curvature adjustment values at the respective scanning angles. In some embodiments, the control signals may be voltage signals applied to a piezoelectrical actuator that adjusts the curvature adjustment in scanning mirror 401 using piezoelectrical actuation. In some alternative embodiments, the control signals may be electrical signals applied to electro-thermal actuator that adjusts the curvature adjustment in scanning mirror 401 by causing a thermal expansion.

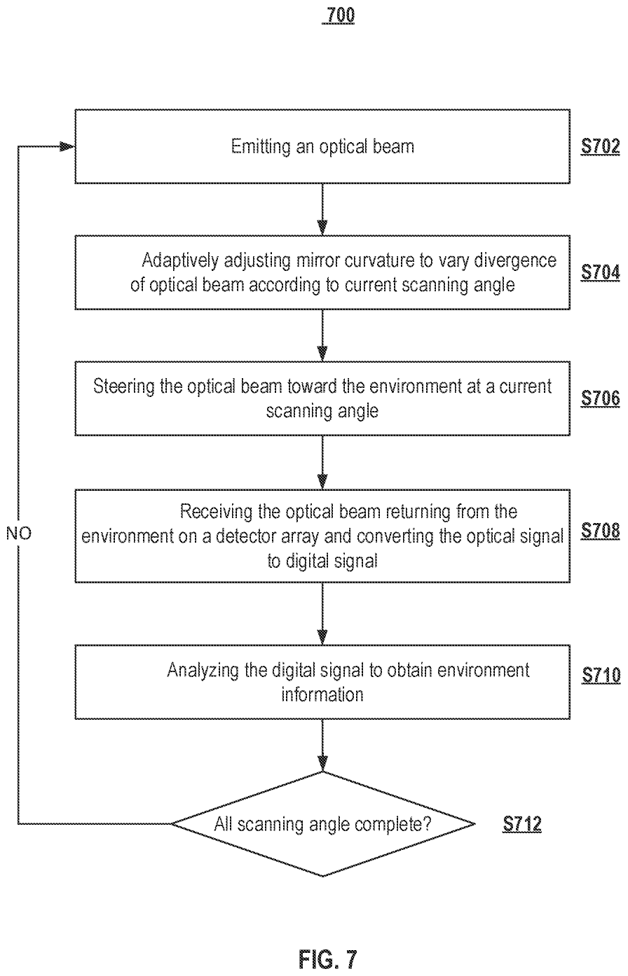

FIG. 7 is a flow chart of an exemplary optical sensing method 700 of a LiDAR system containing a surface curvature adjustable scanner, according to embodiments of the disclosure. In some embodiments, method 700 may be performed by various components of LiDAR system 102, e.g., transmitter 202 containing scanner 212 with an adjustable surface curvature, receiver 204, and/or controller 206. In some embodiments, method 700 may include steps S702-S712. It is to be appreciated that some of the steps may be optional. Further, some of the steps may be performed simultaneously, or in a different order than that shown in FIG. 7.

In step S702, an optical source (e.g., laser emitter 208) inside a transmitter of an optical sensing system (e.g., transmitter 202 of LiDAR system 102) may emit an optical beam (e.g., laser beam 207). In some embodiments, as part of step S702, a collimation lens (e.g., collimation lens 210 of LiDAR system 102) may collimate the optical beam emitted by the light source to a beam (e.g., laser beam 209) of an initial beam divergence. Laser beam 209 is then incident on a scanner of the optical sensing system (e.g., scanner 212 in transmitter 202 of LiDAR system 102) to be steered in a certain direction towards the surrounding environment according to a current scanning angle of the scanner.

In step S704, a controller (e.g., controller 206) may dynamically and adaptively adjust the surface curvature of the scanning mirror (e.g., scanning mirror 401) in the scanner to vary the divergence of the laser beam according to the current scanning angle. In some embodiments, mirror curvature determination unit 642 may determine a curvature adjustment value based on a current scanning angle of the scanner. For example, the deformation distribution δ(x, y) of the scanning mirror may be determined to be linearly proportional to the current scanning angle of the scanner, e.g., according to Equation (1). An effective curvature R is then determined by fitting to the deformation distribution, and the curvature adjustment amount is determined to compensate for the effective curvature. As a result, a smaller curvature adjustment value may be applied to the scanning mirror at a smaller scanning angle (e.g., first scanning angle 410). Similarly, a larger curvature adjustment value may be applied to the scanning mirror at a larger scanning angle (e.g., second scanning angle 420).

Curvature control signal generation unit 644 may then generate a curvature control signal according to the type of actuation used to actuate the curvature adjustment. In some embodiments, the control signals may be voltage signals applied to a piezoelectrical actuator to cause a mechanical displacement in the scanner that bends the surface curvature of the scanning mirror. In some alternative embodiments, the control signals may be electrical signals applied to electro-thermal actuator to cause thermal expansion in the scanner that bends the surface curvature of the scanning mirror. The control signals are then applied to the curvature actuator of the scanner to adjust the scanner for the determined curvature adjustment value.

In some embodiments, in step S704, the controller may adjust the surface curvature to be convex to increase the divergence of the optical beam, such as shown in (b) of FIG. 5. Alternatively, the controller may adjust the surface curvature to be concave to reduce the divergence of the optical beam, such as shown in (c) of FIG. 5. By adjusting the surface curvature of the scanning mirror, method 700 can level the divergence of the transmitter outgoing beam and make it substantially uniform among the different scanning angles.

In step S706, the scanner (e.g., scanner 212) may steer the optical beam with adjusted divergence (e.g., laser beam 211) towards the environment surrounding the optical sensing system (e.g., towards object 214) at the current scanning angle. Objects in the environment may refract at least portions of the optical beam (e.g., laser beam 213) back to the optical sensing system. The returning optical beam may have a certain beam spot size (e.g., beam spot size 613) when detected by a detector (e.g., detector 220 of LiDAR system 102) of the optical sensing system. If the beam divergence is controlled as previously described, the returning beam spot size may be generally uniform and substantially similar or comparable to the receiving aperture (e.g., size of detector 220).

In step S708, the receiver (e.g., receiver 204) of the optical sensing system may receive the returning optical beam (e.g., laser beam 213). The receiver may include a detector (e.g., detector 220) with multiple detector elements or pixels. The retuning optical beam may be detected by one or more pixels inside the detector. Due to the optimized beam spot size, the picked-up signal by each pixel may have a proper signal intensity. In some embodiments, these received optical signals may be converted to electrical signals and further to digital signals, which are then forwarded to a signal processing system or data analysis system of the optical sensing system (e.g., controller 206 of LiDAR system 102).

In step S710, the signal processing system or data analysis system of the optical sensing system may further process the digital signals received from the receiver. The signal processing may include constructing a high-definition map or 3-D buildings and city modeling based on the received digital signals. In some embodiments, the signal processing may also include identifying the objects in the environment surrounding the system, and/or the corresponding distance information of these objects.

In step S712, it is determined whether all scanning angle has been cycled through for the scan. If so (S712: YES), method 700 may conclude. Otherwise (S712: NO), the scanner may be rotated to the next scanning angle and steps S702-S710 will be repeated for the new scanning angle. The surface curvature of the scanning mirror is dynamically and adaptively adjusted at the different scanning angles to ensure that the outgoing beams from transmitter 202 (e.g., laser beams 211) have a substantially uniform divergence over the entire FOV.

Although the disclosure is made using a LiDAR system as an example, the disclosed embodiments may be adapted and implemented to other types of optical sensing systems that use receivers to receive optical signals not limited to laser beams. For example, the embodiments may be readily adapted for optical imaging systems or radar detection systems that use electromagnetic waves to scan objects.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor-based, tape-based, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. An optical sensing system, comprising:
an optical source, configured to emit optical signals;
a scanner configured to steer the optical signals towards an environment surrounding the optical sensing system at a plurality of scanning angles, wherein a surface curvature of the scanner is adaptively adjusted to change a divergence of the optical signals at the respective scanning angles; and
a receiver configured to receive the optical signals returning from the environment.

2. The optical sensing system of claim 1, further comprising a controller configured to:
determine a curvature adjustment value based on a current scanning angle of the scanner; and
generate a curvature control signal to be applied to the scanner to adjust the scanner for the curvature adjustment value.

3. The optical sensing system of claim 2, wherein the scanner comprises a piezoelectric actuator, wherein the curvature control signal is an electrical signal applied to the piezoelectric actuator to cause a mechanical displacement in the scanner that bends the surface curvature.

4. The optical sensing system of claim 2, wherein the scanner comprises an electric-thermal actuator, wherein the curvature control signal is an electrical signal applied to the electric-thermal actuator to cause a thermal expansion in the scanner that bends the surface curvature.

5. The optical sensing system of claim 2, wherein the curvature adjustment value is determined to be linearly proportional to the current scanning angle of the scanner.

6. The optical sensing system of claim 1, wherein the surface curvature is adjusted to be convex to increase the divergence of an optical signal or concave to reduce the divergence of the optical signal.

7. The optical sensing system of claim 1, wherein the optical signals include a first optical signal and a second optical signal steered by the scanner at a first scanning angle and a second scanning angle respectively, wherein the surface curvature is adjusted to add a first divergence and a second divergence to the first optical signal and the second optical signal respectively, wherein the first scanning angle is smaller than the second scanning angle and the first divergence is smaller than the second divergence.

8. The optical sensing system of claim 7, wherein the surface curvature is adjusted for a first curvature adjustment value and a second curvature adjustment value at the first scanning angle and the second scanning angle respectively, wherein the first curvature adjustment value is smaller than the second curvature adjustment value.

9. The optical sensing system of claim 1, wherein the scanner comprises a surface curvature actuator configured to adjust the surface curvature, wherein the surface curvature actuator is formed on a first surface of the scanner opposite to a second surface of the scanner configured to refract the optical signals to the plurality of scanning angles.

10. The optical sensing system of claim 9, wherein the surface curvature actuator is a layer of piezoelectrical material or thermoelectric material coated on the first surface of the scanner.

11. The optical sensing system of claim 1, wherein the scanner is a micro-electromechanical system (MEMS) mirror.

12. An optical sensing method for an optical sensing system comprising a scanner, comprising:
emitting optical signals towards the scanner;
adaptively adjusting a surface curvature of the scanner to change a divergence of the optical signals corresponding to a plurality of scanning angles;
steering the optical signals towards an environment surrounding the optical sensing system at the plurality of scanning angles; and
receiving the optical signals returning from the environment.

13. The optical sensing method of claim 12, wherein adaptively adjusting the surface curvature of the scanner further comprises:
determining a curvature adjustment value based on a current scanning angle of the scanner; and
generating a curvature control signal to be applied to the scanner to adjust the scanner for the curvature adjustment value.

14. The optical sensing method of claim 13, wherein the scanner comprises a piezoelectric actuator, wherein the curvature control signal is an electrical signal applied to the piezoelectric actuator to cause a mechanical displacement in the scanner that bends the surface curvature.

15. The optical sensing method of claim 13, wherein the scanner comprises an electric-thermal actuator, wherein the curvature control signal is an electrical signal applied to the electric-thermal actuator to cause thermal expansion in the scanner that bends the surface curvature.

16. The optical sensing method of claim 13, wherein the curvature adjustment value is determined to be linearly proportional to the current scanning angle of the scanner.

17. The optical sensing method of claim 12, wherein adaptively adjusting the surface curvature of the scanner to change the divergence of the optical signals further comprises:
adjusting the surface curvature to be convex to increase the divergence of an optical signal; or
adjusting the surface curvature to be concave to reduce the divergence of the optical signal.

18. The optical sensing method of claim 12, wherein the optical signals include a first optical signal and a second optical signal, wherein adaptively adjusting the surface curvature of the scanner to change the divergence of the optical signals corresponding to a plurality of scanning angles further comprises:
adjusting the surface curvature for a first curvature adjustment value at a first scanning angle to add a first divergence to the first optical signal; and
adjusting the surface curvature for a second curvature adjustment value at a second scanning angle to add a second divergence to the second optical signal, wherein the first scanning angle is smaller than the second scanning angle, the first curvature adjustment value is smaller than the second curvature adjustment value, and the first divergence is smaller than the second divergence.

19. A transmitter for an optical sensing system, comprising:
an optical source configured to emit optical signals; and
a scanner configured to steer the optical signals towards an environment surrounding the optical sensing system at a plurality of scanning angles, wherein a surface curvature of the scanner is adaptively adjusted to change a divergence of the optical signals at the respective scanning angles.

20. The transmitter of claim 19, wherein the surface curvature is adjusted to be convex to increase the divergence of an optical signal or concave to reduce the divergence of the optical signal.
